(19) United States
(12) Patent Application Publication
(10) Pub. No.: US 2015/0115190 A1
(43) Pub. Date: Apr. 30, 2015

(54) WEAR-RESISTANT VALVE ASSEMBLY

(71) Applicant: YI-MING FAN, Taoyuan Hsien (TW)

(72) Inventor: YI-MING FAN, Taoyuan Hsien (TW)

(21) Appl. No.: 14/062,911

(22) Filed: Oct. 25, 2013

(51) Int. Cl. F16K 25/00; F16K 25/04; F16K 1/22

(52) U.S. Cl. CPC F16K 25/005; F16K 1/22; F16K 25/04
USPC 251/306

(57) ABSTRACT

A wear-resistant valve assembly includes a valve body; a stem penetrating through the valve body; a valve disk installed in the chamber of the valve body and contacting an inner wall of the valve body; a valve body wear-resistant layer formed at an inner annular area of the valve body, which is also at a position contacting the valve disk; and a valve disk wear-resistant layer formed on an outer annular area of the valve disk at a position contacting the valve body; and wherein the valve body wear-resistant layer and the valve disk wear-resistant layer are made of materials selected from carbon alloys and satellite alloys. Furthermore, the valve disk is a triple-eccentric structure; and a drain-proof-ring wear-resistant layer and a valve seat wear-resistant layer are further formed.

### FIELD OF THE INVENTION

The present invention related to drain-proof of valves, and in particular to a wear-resistant valve assembly.

### BACKGROUND OF THE INVENTION

With reference to FIG. 8, a prior art valve assembly is illustrated. The valve includes a valve body 1′. A valve chamber 10′ is formed in an inner side of the valve body. A stem 2′ passes through the valve body 1′. A top end of the stem is connected to an operator (not shown) for driving th valve body 1′ to rotate. A valve seat 30′ is formed in an inner annular wall of chamber 10′ of the valve body 1′. A valve unit 31′ is installed within the chamber 10′ to be in contact with the valve seat 30′. A radial hole 310′ is formed to penetrate through the valve unit 31′ for receiving the stem 2′. Rotation of the stem 2′ will control the valve unit 31′ so as to open or close the valve assembly. In this embodiment, the valve seat 30′ has an approximately round ring form and a cross section along a radial path of the valve seat 30′ is a trapezoidal shape. In this embodiment, the valve seat is detachable. A drain proof assembly 3′ is further installed in the valve unit 3′. In this embodiment, the drain proof assembly 3′ is a drain proof ring 32′ which is installed in an annular recess formed along an outer annular wall of the valve unit 31′. The drain proof ring 32′ resists against an inner wall of the valve seat 30′. A water proof washer 33′ is a round ring and is installed in a trench formed in a wall of the recess of the valve unit 30′. An outer side of the drain proof washer 33′ resists against an annular lateral wall of the drain proof ring 32′

In above mentioned prior art structure, although the drain proof ring 32′ and the drain proof washer 33′ have the effect of water proof, but as the valve is used for a long time, it is possible that the frictions between the drain proof ring, drain proof washer and the valve seat will damage the valve assembly so that the drain proof effect is deteriorated.

Therefore, there is an eager demand for a novel device which can improve the prior art defect and has the effect of enhancing the seal effect between the elements of the valve unit. However, it is helpful to prolong the lifetime of the valve.

Therefore, there is an eager demand for a novel design which can improve the above mentioned defects.

### SUMMARY OF THE INVENTION

Accordingly, the object of the present invention is to provide wear-proof valve assembly, wherein a valve disk wear-resistant layer is in contact with a valve body wear-resistant layer and a drain-proof-ring wear-resistant layer is in contact with a valve seat wear-resistant layer, and thus the wear proof effect of the valve is preferred than those of no wear-resistant. Therefore, even the valve is used for a longer time, the drain-proof of the valve is retained as the original valve. The lifetime of the valve is prolonged and the maintenance work is reduced greatly.

### BRIEF DESCRIPTION OF THE DRAWINGS

FIG. 1 is an exploded view of the valve assembly of the present invention.

FIG. 2 is an assembly view of the valve assembly illustrated in FIG. 1.

FIG. 3 is a cross sectional view showing the contact area of the valve body wear-resistant layer and valve disk wear-resistant layer.

FIG. 4 is a cross sectional view about the second embodiment of the present invention which is suitable for a triple eccentric valve assembly, wherein the contact area of the valve body wear-resistant layer and valve disk wear-resistant layer is illustrated.

FIG. 5 is an exploded view about the third embodiment of the present invention.

FIG. 6 is a perspective view about the third embodiment of the present invention.

FIG. 7 is a cross sectional view about the third embodiment of the present invention.

FIG. 8 is an exploded view about the prior art valve assembly.

FIG. 9 is a cross sectional view about the valve disk of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

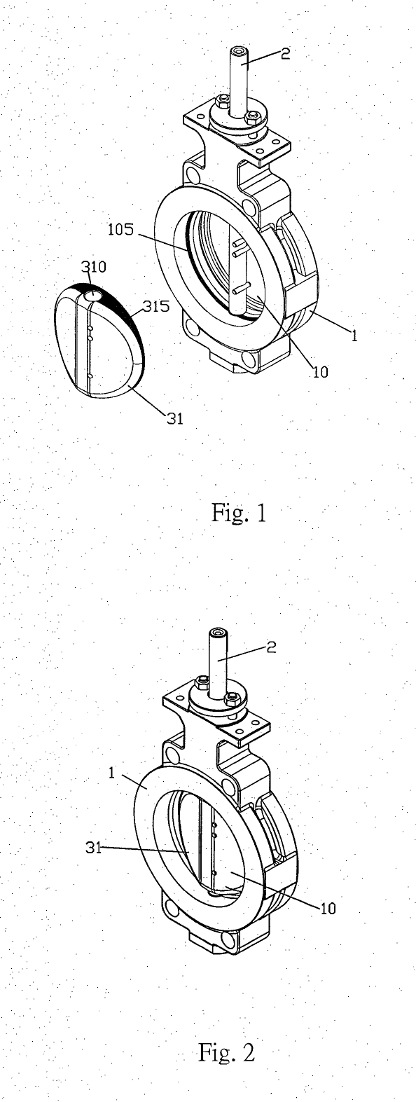

With reference to FIGS. 1 to 5, the detained structure of the triple-eccentric valve according to the present invention is illustrated.

The structure of the present invention has the following elements.

A valve body 1 has a chamber 10 therein.

A stem 2 penetrates through the valve body 1 so as to protrude into the chamber 10 (see FIG. 2). A top end protruded from the valve body 1 has an operation unit (not shown) for driving the stem 2 to rotate.

A valve disk 31 is installed in the chamber 10 of the valve body 1 and contacts an inner wall of the valve body 1. A radial hole 310 (see FIG. 1) is formed radially along the valve disk 31 for receiving the stem 2 so that rotation of the stem 2 will rotate the valve disk 31 for opening or closing the valve.

The feature of the present invention is that a valve body wear-resistant layer 105 is formed at an inner ring area of the valve body, which is also at a position contacting the valve disk 31. The valve body wear-resistant layer 105 is made of carbon alloy, such as tungsten carbide or chromium carbide; or satellite alloy such as stellite-6, stellite-12, stellite-20. In manufacturing, the valve body wear-resistant layer 105 is formed by the method of flame ultrasonic spray.

A valve disk wear-resistant layer 315 is formed on an outer ring of the valve disk 31 at a position contacting the valve body 1. The the valve disk wear-resistant layer 315 is made of carbon alloy, such as tungsten carbide or chromium carbide; or satellite alloy such as stellite-6, stellite-12, stellite-20. In manufacturing, the valve disk wear-resistant layer 315 is formed by the method of flame ultrasonic spray.

In assembly, the valve disk 31 is installed in the chamber 10 of the valve body 1 and contacts an inner wall of the annular seat 30. The stem 2 passes through radial hole 310 along the valve disk 31 so that rotation of the stem 2 will rotate the valve disk 31 for opening or closing the valve. At this state, the valve body wear-resistant layer 105 is in contact with the valve disk wear-resistant layer 315. Due to the wear-resistant effect of the two wear-resistant layers, the wearing in the valve body 1 and the valve disk 31 is greatly reduced. Thus the drain-proof of the valve is retained as the original valve. As a result the lifetime of the valve is prolonged. Maintenance and repairing works of the valve is reduced.

Furthermore, in one embodiment of the present invention, the valve disk 31 of the present invention is formed as a triple-eccentric structure. The detail will be described herein with referring to FIG. 4.

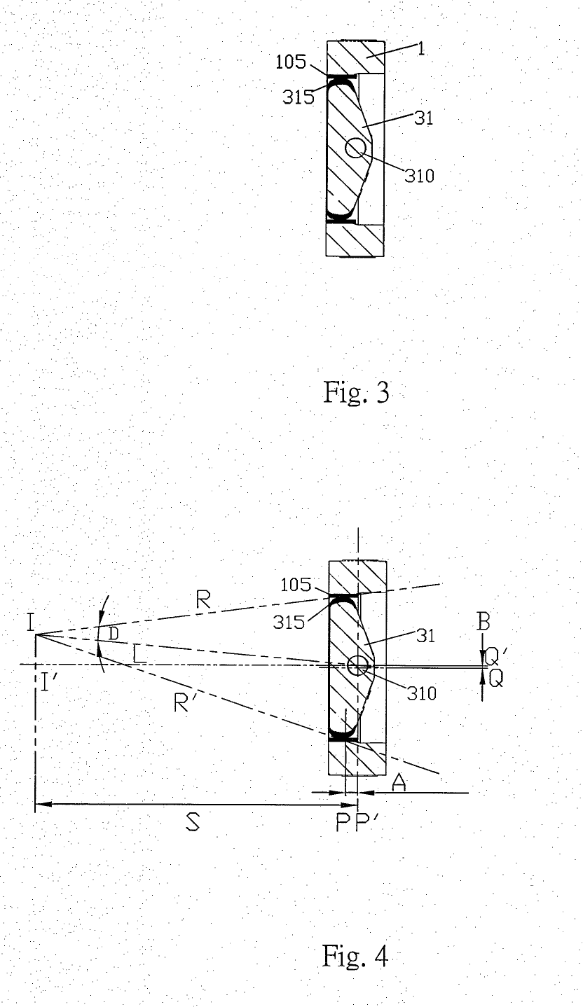

A maximum radial axis P of the valve disk 31 is shifted with a distance A from a radial line P′ passing transversal center of the chamber 10 (see FIG. 3).

Furthermore, an axial central line Q of the valve disk 31 is shifted from an axial center line Q′ of the chamber 10 of the valve body 1.

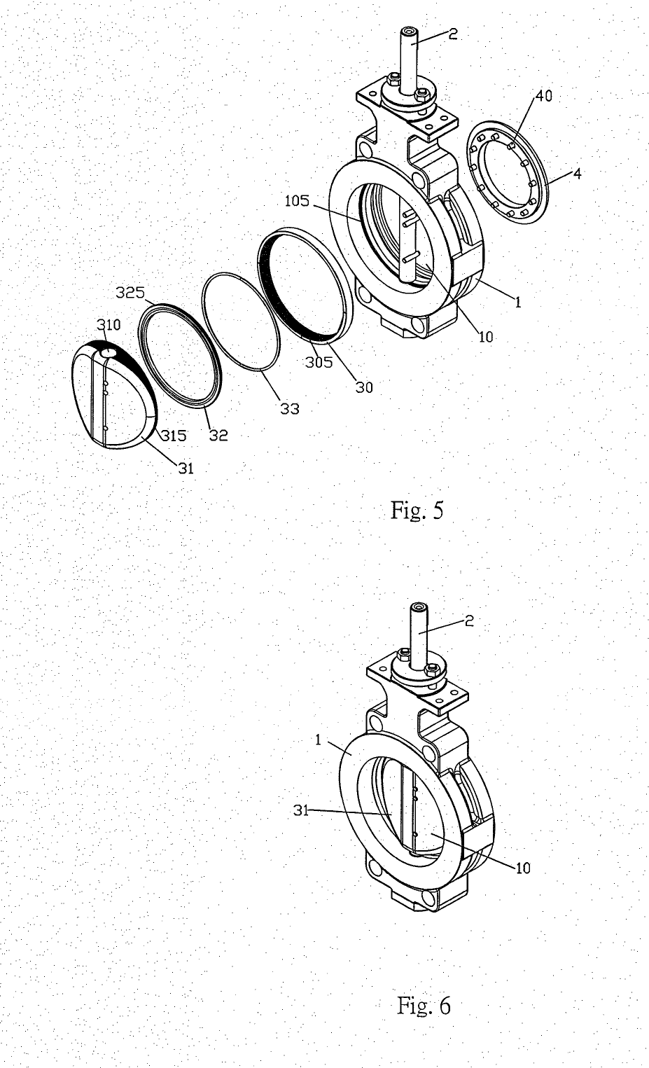

With reference to FIG. 4, it is illustrated, that the conical shape of the valve disk 31 is an asymmetric conical shape according to the present invention. Slopes of tangent lines along a lateral side of the valve disk 31 are gradually changed from a largest one to a smallest one. An upper tangent line R tangent to an upper edge of the disk 31 has a largest slope; and a lower tangent line R′ tangent to a lower edge of the disk 31 has a smallest slope, but not horizontal. The upper tangent line R is intersected with the lower tangent line R′ at a point I, as illustrated in FIGS. 4 and 5, where the absolute value of the slope of the upper tangent line is smaller than that of the lower tangent line. A distance from the intersect point Ito the axial central line Q′ of the chamber 10 is smaller than a radius of the valve disk 31.

As illustrated in FIG. 4, in this triple-eccentric structure, a valve body wear-resistant layer 105 is formed at an inner ring area of the valve body, which is also at a position contacting the valve disk 31. The valve body wear-resistant layer 105 is made of carbon alloy, such as tungsten carbide or chromium carbide; or satellite alloy such as stellite-6, stellite-12, stellite-20. In manufacturing, the valve body wear-resistant layer 105 is formed by the method of flame ultrasonic spray.

A valve disk wear-resistant layer 315 is formed on an outer ring of the valve disk 31 at a position contacting the valve body 1. The valve disk wear-resistant layer 315 is made of carbon alloy, such as tungsten carbide or chromium carbide; or satellite alloy such as stellite-6, stellite-12, and stellite-20. In manufacturing, the valve disk wear-resistant layer 315 is formed by the method of flame ultrasonic spray.

With reference to FIGS. 5 and 6, another embodiment of the present invention is illustrated. The embodiment is similar to those said above, and thus the elements with the numerals of this embodiment identical to those in above embodiment have the same functions as those in above embodiment. Therefore, only those different connected the two embodiments are described herein. Other than the valve body 1 and the valve disk 31, the structure in this embodiment further comprises the following elements.

An annular seat 30 is received in an annular trench formed in a wall of the chamber 10. A radial cross section of the annular seat 30 has a trapezoidal shape. In the present invention, the annular seat 30 is detachable.

A drain proof structure 3 includes the following elements:

A drain-proof ring 32 is an O ring and is arranged at an outer side of the valve disk 31 to resist against the valve seat 30.

The drain-proof ring 32 is preferably made of silicon gal or graphite or PTEF, etc. In assembly state, a periphery of the drain-proof ring 32 resists against an inner wall of the annular seat 30 so as to tightly seal the space between the drain-proof ring 32 and the annular seat 30.

A waterproof washer 33 is a ring and is received in the annular trench at one side of the valve disk 31 and is between the valve disk 31 and the rain proof ring 32. Preferably, the waterproof washer 33 is made of metal or metal alloy.

As illustrated in FIG. 5, in this structure, a valve body wear-resistant layer 105 is formed at an inner annular area of the valve body 1, which is also at a position contacting the valve disk 31. The valve body wear-resistant layer 105 is made of carbon alloy, such as tungsten carbide or chromium carbide; or satellite alloy such as stellite-6, stellite-12, or stellite-20. In manufacturing, the valve body wear-resistant layer 105 is formed by the method of flame ultrasonic spray.

A valve disk wear-resistant layer 315 is formed on an outer annular area of the valve disk 31 at a position contacting the valve body 1. The valve disk wear-resistant layer 315 is made of carbon alloy, such as tungsten carbide or chromium carbide; or satellite alloy such as stellite-6, stellite-12, and stellite-20. In manufacturing, the valve disk wear-resistant layer 315 is formed by the method of flame ultrasonic spray.

Moreover, as illustrated in FIG. 5, in this structure, a drain-proof ring wear-resistant layer 325 is formed at outer annular area of the drain-proof ring 32 contacting the valve body 1. The drain-proof-ring wear-resistant layer 325 is made of carbon alloy, such as tungsten carbide or chromium carbide; or satellite alloy such as stellite-6, satellite-12, a and stellite-20. In manufacturing, the drain-proof ring wear-resistant layer 325 is formed by the method of flame ultrasonic spray.

A valve seat wear-resistant layer 305 is formed on an inner annular area of the annular seat 30 at a position contacting the valve disk 1. The valve seat wear-resistant layer 305 is made of carbon alloy, such as tungsten carbide or chromium carbide; or satellite alloy such as stellite-6, stellite-12, and stellite-20. In manufacturing, the valve body wear-resistant layer 105 is formed by the method of flame ultrasonic spray. With reference to FIG. 5, it is illustrated that an annual cover 4 is fitted into the stepped recess 311. A lateral side of the annular cover 4 is formed with a plurality of protrusions 40 for locking to the valve disk 31.

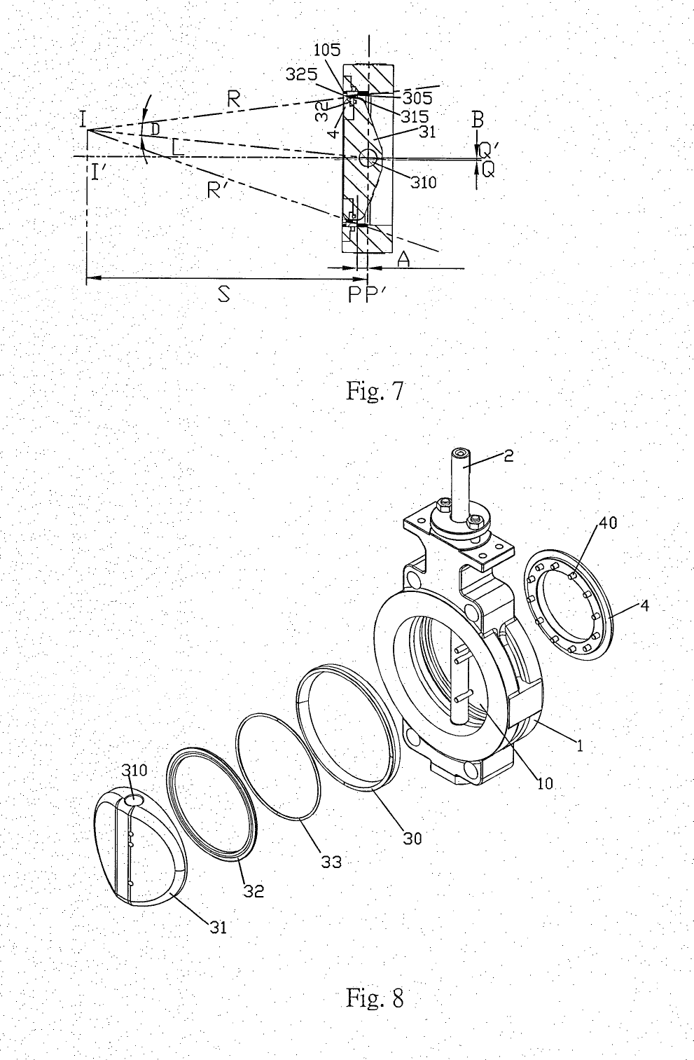

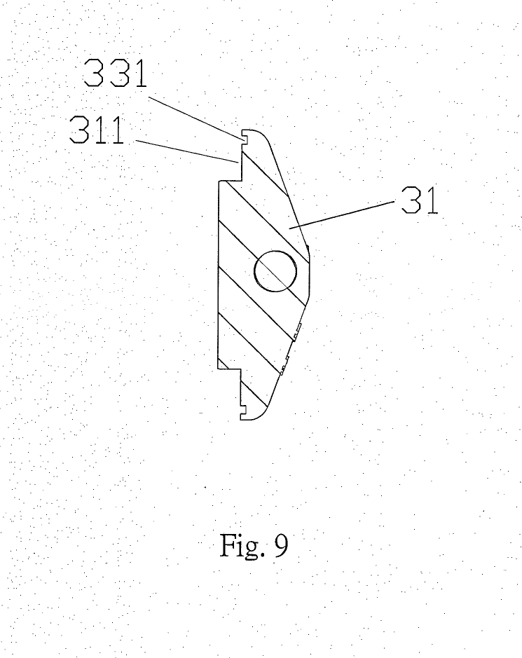

Referring to FIGS. 7 and 9, in the present invention, in assembly, the annular seat 30 is installed to the valve body 1. The annular seat 30 is installed between the cover 4 and the lateral side of the valve body 1. Then the waterproof washer 33 is installed to the annular trench 331 of the valve disk 31. The drain-proof ring 32 is arranged in the stepped recess 311 of the valve disk 31 to seal the waterproof washer 33. The annual cover 4 is fitted to the stepped recess 311. Then the valve disk 31 is placed to the chamber 10 of the valve body 1. The stem 2 penetrates through the valve body 1 so as to protrude into the chamber 10. The top end thereof protrudes from the valve body 1 has an operation unit (not shown) for driving the stem 2 to rotate. Then the stem 2 passes through the radial hole 310 so that rotation of the stem 2 will rotate the valve disk 31. The drain-proof unit 3 is installed between the valve disk 31 and the valve body 1. In maintenance, it is only needed to detach the annular cover 4 from the valve disk 31 and then take out the drain-proof ring 32 and waterproof washer 33 from the valve disk 31. The operation is easy and convenient.

Moreover, the valve disk wear-resistant layer 315 is in contact with the valve body wear-resistant layer 105 and the drain-proof-ring wear-resistant layer 325 is in contact with the valve seat wear-resistant layer 305, and thus the wear proof effect of the valve is preferred than those of no wear-resistant. Therefore, even the valve is used for a longer time, the drain-proof of the valve is retained as the original valve. The lifetime of the valve is prolonged and the maintenance work is reduced greatly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wear-resistant valve assembly, comprising:
a valve body having a chamber therein;
a stem penetrating through the valve body so as to protrude into the chamber; a top end protruding from the valve body having an operation unit for driving the stem to rotate;
a valve disk installed in the chamber of the valve body and contacting an inner wall of the valve body; a radial hole being penetrating radially being the valve disk for receiving the stem so that rotation of the stem will rotate the valve disk for opening or closing the valve;
a valve body wear-resistant layer formed at an inner annular area of the valve body, which is also at a position contacting the valve disk; and
a valve disk wear-resistant layer formed on an outer annular area of the valve disk at a position contacting the valve body; and
wherein the valve body wear-resistant layer and the valve disk wear-resistant layer are made of materials selected from carbon alloys and satellite alloys; and
wherein in assembly, the valve disk is installed in the chamber of the valve body and contacts an inner wall of the annular seat; the stem passes through radial hole along the valve disk that rotation of the stem will rotate the valve disk for opening or closing the valve; at this state, the valve body wear-resistant layer is in contact with the valve disk wear-resistant layer; due to the wear-resistant effect of the two wear-resistant layers, the wearing in the valve body and the valve disk is greatly reduced.

2. The wear-resistant valve assembly as claimed in claim 1, wherein the carbon alloy is selected from tungsten carbide and chromium carbide; and the satellite alloy is selected from stellite-6, stellite-12, and stellite-20.

3. The wear-resistant valve assembly as claimed in claim 1, wherein the valve body wear-resistant layer and the valve disk wear-resistant layer are formed by flame ultrasonic spray.

4. The wear-resistant valve assembly as claimed in claim 1, wherein the valve disk is a triple-eccentric structure; that is a maximum radial axis of the valve disk is shifted with a distance from a radial line passing a transversal center of the chamber; and an axial central line of the valve disk is shifted from an axial center line the chamber of the valve body; and
wherein the valve disk has an asymmetric conical structure; radial slopes of tangent lines on a lateral side of the valve disk are gradually changed from a largest one to a smallest one; an upper tangent line tangent to an upper edge of the disk has a largest slope; and a lower tangent line tangent to a lower edge of the disk has a smallest slope, but not horizontal; the upper tangent line is intersected with the lower tangent line at an intersect point, where the absolute value of the slope of the upper tangent line is smaller than that of the lower tangent line.

5. The wear-resistant valve assembly as claimed in claim 4, further comprising:
an annular seat received in an annular trench formed in a wall of the chamber; and a radial cross section of the annular seat has a trapezoidal shape; and the annular seat being detachable;
a drain proof structure including:
a drain-proof ring being an O ring and being arranged at an outer side of the valve disk for resisting against the valve seat; in assembly state, a periphery of the drain-proof ring resisting against an inner wall of the annular seat so as to tightly seal the space between the drain-proof ring and the annular seat;
a waterproof washer being a ring and being received in the annular trench at one side of the valve disk and being between the valve disk and the rain proof ring;
a drain-proof-ring wear-resistant layer being formed at outer annular area of the drain-proof ring contacting the valve body; the drain-proof-ring wear-resistant layer; and
a valve seat wear-resistant layer formed on an inner annular area of the annular seat at a position contacting the valve disk; and
wherein the valve body wear-resistant layer and the valve disk wear-resistant layer are made of materials selected from carbon alloys and satellite alloys.

6. The wear-resistant valve assembly as claimed in claim 5, wherein the carbon alloy is selected from tungsten carbide and chromium carbide; and the satellite alloy is selected from stellite-6, stellite-12, and stellite-20.

7. The wear-resistant valve assembly as claimed in claim 1, wherein the drain-proof wear-resistant layer and the valve seat wear-resistance layer are formed by flame ultrasonic spray.
